(19) United States
(12) Patent Application Publication
(10) Pub. No.: US 2019/0176455 A1
(43) Pub. Date: Jun. 13, 2019

(54) METHODS FOR PRODUCING PAPER CONTAINERS FOR LIQUID, AND PAPER CONTAINERS FOR LIQUID

(71) Applicant: TOPPAN PRINTING CO., LTD., Tokyo (JP)

(72) Inventors: Aoi KIKUCHI, Tokyo (JP); Kazuhiro HIKIDA, Tokyo (JP)

(73) Assignee: TOPPAN PRINTING CO., LTD., Tokyo (JP)

(21) Appl. No.: 16/277,965

(22) Filed: Feb. 15, 2019

Related U.S. Application Data
(63) Continuation of application No. PCT/JP2017/029684, filed on Aug. 18, 2017.

(30) Foreign Application Priority Data
Aug. 18, 2016 (JP) 2016-160796

(51) Int. Cl. B32B 37/12; B32B 37/02; B32B 37/24; B32B 7/12; B32B 27/36; B32B 27/32; B32B 27/10; B65D 5/40; B65D 65/40; B65D 81/24

(52) U.S. Cl. CPC B32B 37/12; B32B 2310/14; B32B 37/24; B32B 7/12; B32B 27/36; B32B 27/32; B32B 27/10; B65D 5/40; B65D 65/40; B65D 81/24; B32B 2037/246; B32B 2439/70; B32B 2307/7244; B32B 2307/7246; B32B 37/02

(57) ABSTRACT

A method for producing a paper container and a paper container for liquid. A method for producing a paper container for liquid according to an aspect includes a bonding step of bonding a first surface of a substrate and a vapor deposition surface of a barrier laminate film layer via a first adhesive resin layer without applying a corona treatment to the vapor deposition surface of the barrier laminate film layer, a lamination step of laminating at least a second adhesive resin layer on a surface of the barrier laminate film layer on a side opposite to the vapor deposition surface, and a forming step of forming a laminate into a box shape after the bonding step and the lamination step, the laminate including at least the substrate, the first adhesive resin layer, the barrier laminate film layer, and the second adhesive resin layer.

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2017/029684, filed on Aug. 18, 2017, which is based upon and claims the benefit of priority to Japanese Patent Application No. 2016-160796, filed on Aug. 18, 2016; the disclosures of which are all incorporated herein by reference in their entireties.

### TECHNICAL FIELD

The present invention relates to methods for producing paper containers for liquid, and paper containers for liquid produced by these methods.

### BACKGROUND ART

Paper containers for liquids are known as containers for liquid beverages such as fruit beverages, tea, coffee, milk beverages, soup, and alcoholic beverages such as sake and shochu (for example, see PTL 1).

Such containers have a shape such as a gable-top shape, a brick shape, or a cylindrical shape. For example, a brick-shaped paper container for liquid is formed by providing a packaging material having a thermoplastic resin layer on each side of a paper layer, creating a score line for a package of the packaging material, adhering an edge protection tape on the end of the packaging material, forming the packaging material into a tubular shape, bonding the overlapped ends of the packaging material to each other to form a tube, sealing the lower end of the packaging material in a traverse direction, filling the tube with contents, separating the tube using a liquid-filled seal, and forming the tube into a three-dimensional shape.

That is, as shown in FIG. 10, such a paper container for liquid is formed of a laminate 1010, in which a thermoplastic resin layer 1002, a substrate 1001, a first adhesive resin layer 1004, a barrier laminate film layer 1003, an anchor coat layer 1007, a thermoplastic resin layer 1005, and a sealant layer 1006 are deposited in this order.

### CITATION LIST

[Patent Literature] PTL 1: Japanese Patent No. 4793562 B2

### SUMMARY

### Technical Problem

Since the paper container is filled with a liquid beverage as described above, an anchor coat layer is preferably not used for the paper container for liquid. Further, high water resistance is preferably maintained.

Since the conventional adhesive resin is adhered to the substrate by hydrogen bonding, van der Waals force, or the like, there is room for improvements in water resistance. Accordingly, there is a demand for paper containers for liquid that can prevent reduction in adhesion strength under high humidity environments and exhibit strength required for paper containers for liquid without having an anchor coat layer, and method for producing the same.

The present invention has been made in view of the above circumstances, and aims to provide a method for producing a paper container for liquid that reduces the production cost by reducing the number of production steps and improves the yield. Further, the present invention aims to provide a paper container for liquid that exhibits sufficient barrier performance against oxygen, water vapor, and the like, and improved water resistance.

### Improved Solution to the Problem

The present invention has the following aspects:

[1] A method for producing a paper container for liquid, the method including: a bonding step of bonding a first surface of a substrate to a vapor deposition surface of a barrier laminate film layer via a first adhesive resin layer without a corona treatment being applied to the vapor deposition surface of the barrier laminate film layer; a lamination step of laminating at least a second adhesive resin layer on a surface of the barrier laminate film layer on a side opposite to the vapor deposition surface; and a forming step of forming a laminate into a box shape after the bonding step and the lamination step, the laminate including at least the substrate, the first adhesive resin layer, the barrier laminate film layer, and the second adhesive resin layer.

[2] A method for producing a paper container for liquid, the method including: a lamination step of laminating a first adhesive resin layer without applying a corona treatment to a vapor deposition surface of a barrier laminate film layer; a bonding step of bonding a surface of the barrier laminate film layer on a side opposite to the vapor deposition surface to a first surface of a substrate via a second adhesive resin layer; and a forming step of forming a laminate into a box shape after the lamination step and the bonding step, the laminate including at least the substrate, the second adhesive resin layer, the barrier laminate film layer, and the first adhesive resin layer.

[3] The method for producing a paper container for liquid, further including a step of providing a thermoplastic resin layer on a second surface of the substrate before the forming step, wherein the lamination step includes laminating a sealant layer on a surface of the barrier laminate film layer on a side opposite to the vapor deposition surface via the second adhesive resin layer.

[4] The method for producing a paper container for liquid, further including a step of providing a thermoplastic resin layer on a second surface of the substrate before the forming step, wherein the lamination step includes laminating a sealant layer on the vapor deposition surface of the barrier laminate film layer via the first adhesive resin layer.

[5] A paper container for liquid produced by forming a laminate into a shape, the laminate at least including: a barrier laminate film layer; a first adhesive resin layer laminated on a first surface of the barrier laminate film layer; a second adhesive resin layer laminated on a second surface of the barrier laminate film layer; and a substrate laminated on one of a surface of the first adhesive resin layer on a side opposite to that facing the barrier laminate film layer and a surface of the second adhesive resin layer on a side opposite to that facing the barrier laminate film layer, wherein the first adhesive resin layer is laminated with a vapor deposition surface formed on the first surface of the barrier laminate film layer being a non-corona treated surface.

[6] The paper container for liquid, wherein the laminate further includes: a thermoplastic resin layer laminated on a surface of the substrate on a side opposite to that facing the barrier laminate film layer; and a sealant layer laminated on the other of the surface of the first adhesive resin layer on a side opposite to that facing the barrier laminate film layer and the surface of the second adhesive resin layer on a side opposite to that facing the barrier laminate film layer.

### Desired Advantageous Effects of Invention

According to the present invention, a method for producing a paper container for liquid that reduces the production cost and improves the yield, and a paper container for liquid that exhibits improved water resistance can be provided.

### BRIEF DESCRIPTION OF THE DRAWINGS

FIG. 1 is a flowchart of a method for producing a paper container for liquid according to Sample 1.

FIGS. 2A, 2B, 2C, and 2D are cross-sectional views in a thickness direction in each step of a method for producing the paper container for liquid according to Sample 1.

FIG. 3A is a cross-sectional view in a thickness direction of the paper container for liquid according to Sample 1, and FIG. 3B is a perspective view of a brick-shaped paper container for liquid.

FIG. 4 is a flowchart of a method for producing a paper container for liquid according to Sample 2.

FIGS. 5A, 5B, 5C, and 5D are cross-sectional views in a thickness direction in each step of a method for producing the paper container for liquid according to Sample 2.

FIG. 6 is a flowchart of a method for producing a paper container for liquid according to Sample 3.

FIGS. 7A, 7B, 7C, and 7D are cross-sectional views in a thickness direction in each step of a method for producing the paper container for liquid according to Sample 3.

FIG. 8 is a flowchart of a method for producing a paper container for liquid according to Sample 4.

FIGS. 9A, 9B, 9C, 9D, and 9E are cross-sectional views in a thickness direction in each step of a method for producing the paper container for liquid according to Sample 4.

FIG. 10 is a cross-sectional view in a thickness direction of a conventional paper container for liquid.

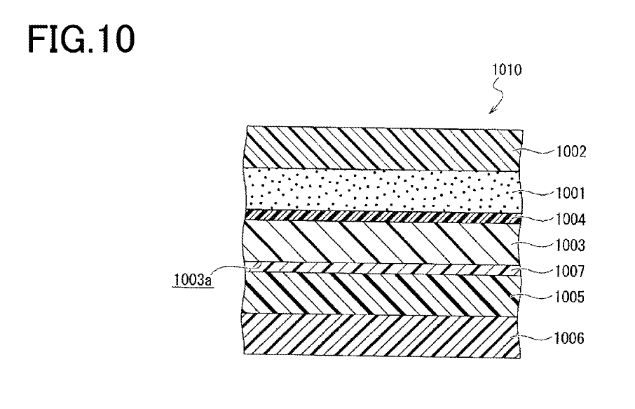

### DETAILED DESCRIPTION OF REPRESENTATIVE EMBODIMENTS

With reference to the drawings, a method for producing a paper container for liquid, and embodiments of a paper container for liquid will be detailed below. Specific configurations of the present invention are not limited to those described in the following embodiments, and modification in design to a degree that does not deviate from the spirit of the present invention should be included within the scope of the present invention. With reference to the drawings, embodiments of the present invention will be described. The present invention is not limited to the following representative embodiments, and appropriate modifications can be made without departing from the spirit of the present invention. The representative embodiments described below are merely examples of the present invention, and the design thereof could be appropriately changed by one skilled in the art. In the drawings referred to in the following description, for clarity, characteristic parts may be enlarged, and thus the components may not be shown to scale. Moreover, the positional relationships, such as up and down, left and right, are based on the positional relationships shown in the drawings, unless otherwise specified. Furthermore, the dimension ratios in the drawings are not limited to the ratios shown therein. The drawings herein are schematic. In the drawings, the relationship between thickness and horizontal dimension, the ratio of thickness of each layer, and the like are not to scale. In order to simplify the drawings, well-known structures are shown simplified. In each drawing, the same reference signs are assigned to constituent elements that exhibit the same or similar functions, and redundant description is omitted. The embodiments described below are merely examples of the configurations for embodying the technical idea of the present invention, and the technical idea of the present invention should not limit the materials, shapes, structures, and the like of the components to those described below. The technical idea of the present invention can be modified in various ways within the technical scope defined by the claims.

(Method for Producing Paper Container for Liquid)

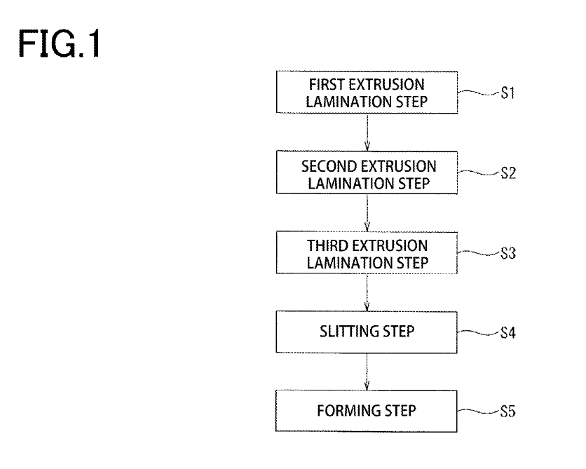

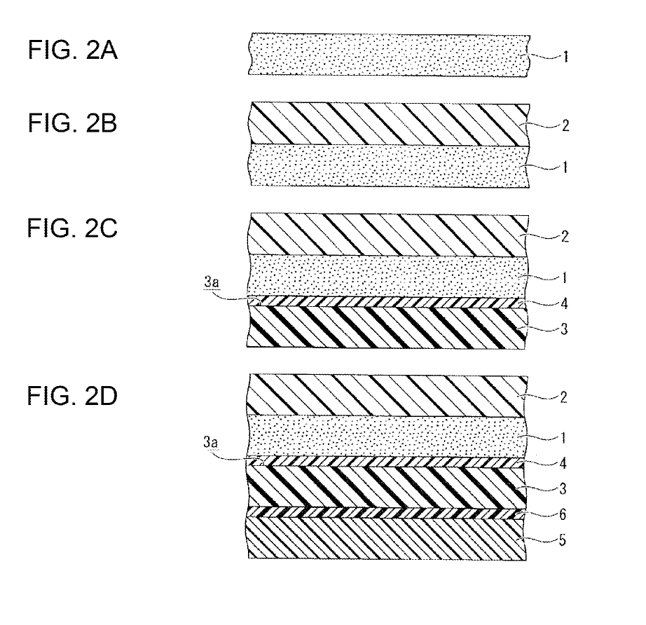

FIG. 1 is a flowchart of a method for producing a paper container for liquid according to the present embodiment. Further, FIGS. 2A, 2B, 2C, and 2D are cross-sectional views in a thickness direction in each step of a method for producing the paper container for liquid according to the present embodiment.

As shown in FIG. 1, a method for producing the paper container for liquid according to the present embodiment includes a first extrusion lamination step S1, a second extrusion lamination step S2, a third extrusion lamination step S3, a slitting step S4, and a forming step S5. In addition, printing steps or score line processing steps may be added as necessary.

<First Extrusion Lamination Step>

In a first extrusion lamination step S1, a substrate 1 formed of a paper sheet shown in FIG. 2A is provided. Then, low density polyethylene is provided on a first surface of the substrate 1 by extrusion lamination to form a thermoplastic resin layer 2. Thus, the laminate shown in FIG. 2B is provided.

Further, prior to the first extrusion lamination step S1, a printing step may also be performed to provide a print layer by applying corona treatment to a surface of the substrate 1 or the thermoplastic resin layer 2, and then gravure printing on the corona-treated surface by using print ink. This printing is preferably performed to the substrate 1, or may be performed to the surface of the thermoplastic resin layer 2. Moreover, a score line processing step may also be performed by which the substrate 1 is punched out into a predetermined blank of a paper container for liquid and simultaneously a score line is formed by press ruling.

<Second Extrusion Lamination Step>

In a second extrusion lamination step S2, as shown in FIG. 2C, a second surface of the substrate 1 and a vapor deposition surface (coat surface) 3a of a barrier laminate film layer 3 such as an alumina vapor deposition polyester film are bonded to each other via a first adhesive resin layer 4 by a melt extrusion lamination technique. Here, a surface treatment such as corona treatment for modifying the coat surface is not applied to the vapor deposition surface 3a of the barrier laminate film layer 3. That is, a technical feature in the second extrusion lamination step S2 is to bond the vapor deposition surface 3a of the barrier laminate film layer 3 as a bonding surface to the first adhesive resin layer 4 for lamination without using an anchoring agent, and not to perform a surface treatment such as corona treatment to the vapor deposition surface 3a. Since the barrier laminate film layer 3, in which corona treatment is not applied to the vapor deposition surface 3a, is laminated on the substrate 1 via the first adhesive resin layer 4 by a melt extrusion lamination technique, it is possible to reduce the processing step and thus the loss generated in a set-up time or an anchor coat step to thereby reduce the production time and improve the yield. In the present invention, this step corresponds to a “bonding step.”

<Third Extrusion Lamination Step>

In a third extrusion lamination step S3, as shown in FIG. 2D, a sealant layer 5 is laminated on a surface of the barrier laminate film layer 3 on a side opposite to the vapor deposition surface 3a by extrusion lamination technique by using a second adhesive resin layer 6 to thereby form a laminate 10. The second adhesive resin layer 6 is made of, for example, a thermal melting resin. Examples of the thermal melting resin used include acid-modified polyolefin resins, which are polyolefin resins such as low density polyethylene (LDPE), medium density polyethylene (MDPE), high density polyethylene (HDPE), linear low density polyethylene (LLDPE), polypropylene (PP), ethylene-vinyl acetate copolymer (EVA), ionomer resin, ethylene-methyl acrylate copolymer (EMA), ethylene-acrylate acid copolymer (EAA), ethylene-methacrylate acid copolymer (EMAA), ethylene-propylene copolymer (EPM), methylpentene polymer, polyethylene and polypropylene, which are modified by unsaturated carboxylic acid such as acrylic acid, methacrylic acid, maleic acid, maleic anhydride, fumaric acid, and itaconic acid.

Further, a surface treatment (corona discharge treatment, ozone treatment, etc.) may be applied as necessary to a surface of the barrier laminate film layer 3 on a side opposite to the vapor deposition surface 3a.

Here, the sealant layer 5 is provided by laminating a molten resin, which is an additive-free low density polyethylene extruded by a T-die, on the barrier laminate film layer 3 by extrusion lamination together with the second adhesive resin layer.

In the present invention, this step corresponds to a “lamination step.”

<Slitting Step>

In a slitting step, a wide continuous sheet-shaped laminate 10 is processed into a tape-shape by a slitting process, and cut at a predetermined length.

<Forming Step>

In a forming step, the laminate 10, cut at a predetermined length in the slitting step, is formed into, for example, a box-shape.

(Configuration of Paper Container for Liquid)

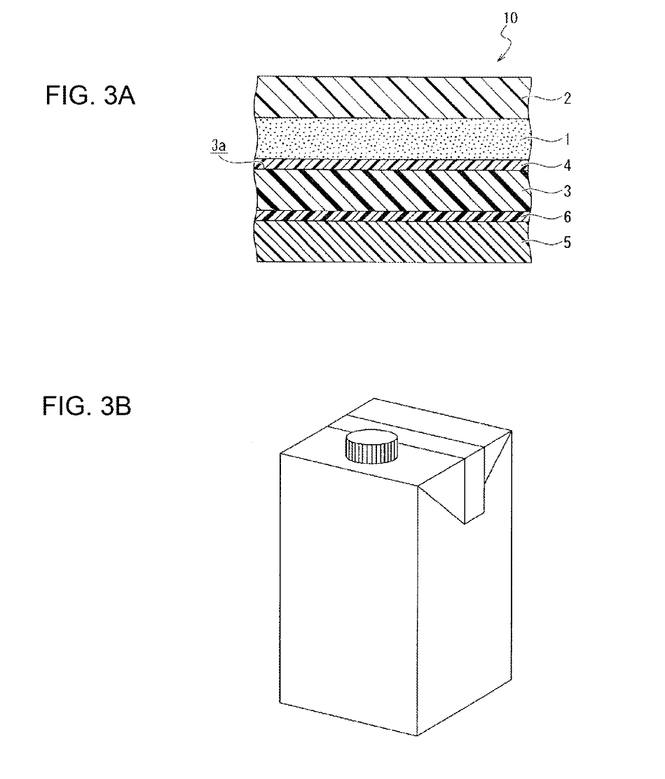

FIGS. 3A and 3B are cross-sectional views in a thickness direction, illustrating a configuration of the paper container for liquid according to the present embodiment.

As shown in FIGS. 3A and 3B, the paper container for liquid of the present embodiment obtained by the aforementioned production method is produced by forming the laminate 10 into a shape, in which the thermoplastic resin layer 2, the substrate 1, the first adhesive resin layer 4, the barrier laminate film layer 3, the second adhesive resin layer 6, and the sealant layer 5 are laminated in this order. Further, the laminate 10 at least includes the barrier laminate film layer 3, and the first adhesive resin layer 4 laminated on the vapor deposition surface 3a of the barrier laminate film layer 3, to which corona treatment is not applied. Alternatively, the laminate 10 may include the substrate 1, the thermoplastic resin layer 2, the first adhesive resin layer 4, and the barrier laminate film layer 3, which are laminated in this order. In this case, the thermoplastic resin layer 2 and the first adhesive resin layer 4 are formed by co-extrusion lamination. With this layer configuration, the production cost can be reduced.

<Substrate>

A paper sheet used for the substrate 1 is not specifically limited as long as formability, shape retention ability, strength and the like of the paper container for liquid are maintained. The shape, volume, and the like of the paper container for liquid are appropriately selected according to the purpose. Specifically, a paper board with a grammage of approximately 50 to 600 g/m² is preferred, and a paper board with a grammage of approximately 200 to 600 g/m² is more preferred. Low grammage results in a failure in obtaining sufficient container performance, and high grammage leads to low formability.

<Thermoplastic Resin Layer>

Materials for the thermoplastic resin layer 2 provided “outside” the laminate 10 can be selected from, for example, ethylene resins such as low density polyethylene resin (LDPE), medium density polyethylene resin (MDPE), high density polyethylene (HDPE), linear low density polyethylene resin (L-LDPE), ethylene-α-olefin copolymer, and polypropylene resins such as homopolypropylene resin, propylene-ethylene random copolymer, propylene-ethylene block copolymer, propylene-α-olefin copolymer. Further, modified polyolefin resins of these olefin resins which are acid-modified by graft polymerization can also be used. That is, the thermoplastic resin layer 2 may be made of any polyolefin having sealing properties. An example of the material for the thermoplastic resin layer 2 is “Novatec LC600A” (manufactured by Japan Polyethylene Corporation). Further, the thickness of the thermoplastic resin layer 2 is preferably approximately in the range of 5 to 200 μm, and more preferably approximately in the range of 10 to 50 μm.

Although not shown in the figure, a print layer of print ink may be provided on the outside the substrate 1 or the thermoplastic resin layer 2. Here, corona treatment can be applied to the surface of the substrate 1 or the thermoplastic resin layer 2 to improve adhesiveness to the print ink.

Examples of the print ink include gravure ink, flexographic ink, silk screen ink, and offset ink. The print layer can be provided according to each printing method. The gravure ink, flexographic ink, and silk screen ink are composed of a coloring agent (organic pigment, inorganic pigment, dye, etc.), a vehicle (an organic solvent of alcohol, ester, ketone, alcohol derivatives, aromatic hydrocarbons, or aliphatic hydrocarbons in which a binder made of synthetic resin is dissolved), and an auxiliary agent (stabilizing agent, slipping agent, etc.).

Further, the offset ink is composed of a coloring agent (organic pigment, or inorganic pigment), a vehicle (synthetic resin, drying oil, or organic solvent), and an auxiliary agent (viscosity adjusting agent, dry adjusting agent, etc.).

<First Adhesive Resin Layer>

The first adhesive resin layer 4, used in bonding by extrusion lamination of the substrate 1 and the barrier laminate film layer 3, is a thermal melting resin. Examples of the thermal melting resin used include acid-modified polyolefin resins, which are polyolefin resins such as low density polyethylene (LDPE), medium density polyethylene (MDPE), high density polyethylene (HDPE), linear low density polyethylene (LLDPE), polypropylene (PP), ethylene-vinyl acetate copolymer (EVA), ionomer resin, ethylene-methyl acrylate copolymer (EMA), ethylene-acrylate acid copolymer (EAA), ethylene-methacrylate acid copolymer (EMAA), ethylene-propylene copolymer (EPM), methylpentene polymer, polyethylene and polypropylene, which are modified by unsaturated carboxylic acid such as acrylic acid, methacrylic acid, maleic acid, maleic anhydride, fumaric acid, and itaconic acid.

Among others, ADMER SE810 (polyethylene graft-copolymerized with maleic anhydride, manufactured by Mitsui Chemicals, Inc.) is specifically preferred as the first adhesive resin layer 4.

Further, the melt extrusion temperature of the first adhesive resin layer 4 is preferably in the range of 295 to 305° C. Low temperature causes insufficient adhesiveness, while high temperature causes decomposition of the resin.

The thickness of the first adhesive resin layer 4 is appropriately determined depending on the application within the range that does not disturb the object of the present invention, and is preferably in the range of 10 to 100 μm, and more preferably in the range of 10 to 50 μm. When the thickness of the first adhesive resin layer 4 is 5 μm or less, a sufficient adhesion strength may not be performed.

Further, a surface treatment (corona discharge treatment, ozone treatment, etc.) is not applied to either a surface of the substrate 1 or the vapor deposition surface 3a. If applied, a surface treatment causes the initial adhesion strength to be higher than that of an unprocessed surface. However, the strength is significantly lowered in high humidity environments. Further, for the surface of the substrate 1, an anchor coat agent or the like may be applied to the surface of the substrate 1 if necessary.

Further, the substrate 1 and the barrier laminate film layer 3 may also be bonded to each other by dry lamination. In this case, a dry lamination adhesive is used as the first adhesive resin layer 4. The dry lamination adhesive may be appropriately selected, and is preferably, for example, a urethane-based adhesive composed of polyester polyol or polyester polyurethane polyol as a base resin and an isocyanate-based hardener as a hardener. The amount of dry lamination adhesive to be applied is preferably in the range of 1 to 6 g/m² in dry-cured weight.

<Barrier Laminate Film Layer>

The barrier laminate film layer 3 is preferably a barrier laminate film in which a barrier layer is disposed on a barrier resin film or a substrate film, taking into consideration the ease of disposal.

[Barrier Resin Film]

Examples of the barrier resin film include films such as an ethylene-vinyl alcohol copolymer film (EVOH), a polyvinyl alcohol film (PVA), a laminate film of a biaxially-oriented polyethylene terephthalate or a biaxially-oriented Nylon film and ethylene-vinyl alcohol copolymer, and a saponified ethylene-vinyl acetate copolymer (EVA) film, and laminate films made of any one of these films or a combination of two or more of these films.

Examples of the barrier laminate film include coated films in which polyvinylidene chloride is coated on a film such as polyethylene terephthalate (PET), polyamide (PA), or polypropylene (PP) film, aluminum laminated films on which an aluminum foil is laminated, and aluminum vapor deposition films or inorganic oxide vapor deposition films, on which a vapor deposition thin film layer of aluminum metal or inorganic oxide (silicon oxide, aluminum oxide, etc.) is disposed by vacuum vapor deposition, sputtering, or the like, and laminate films made of any one of these films or a combination of two or more of these films.

Further, two or more layers of the above vapor deposition layer (vapor deposition film) may also be provided. If necessary, an optional substrate (a typical food-packaging resin layer or film such as Nylon) may be combined.

Further, examples of the substrate film used for the above barrier laminate film include unstretched or stretched films of polyester such as polyethylene terephthalate (PET), polyethylene naphthalate (PEN), or polybutylene terephthalate (PBT), polyolefin such as polypropylene (PP), or polystyrene (PS), polyamide (PA) such as Nylon-6, or Nylon-66, polycarbonate (PC), polyacrylonitrile (PAN), polyimide (PI), and the like.

Further, a primer coat layer may also be provided between the substrate film and the vapor deposition thin film layer, or a primer treatment may be applied, so that the gas barrier resin film has an improved adhesiveness between the substrate film and the vapor deposition thin film layer. The material for the primer coat layer is preferably selected from the group consisting of solvent soluble or water soluble polyester resins, isocyanate resins, urethane resins, acrylic resins, vinyl alcohol resins, ethylene vinyl alcohol resins, vinyl modified resins, epoxy resins, oxazoline group-containing resins, modified styrene resins, modified silicone resins, alkyl titanate, and the like. These can be used singly or in a combination of two or more. The primer treatment can be applied by using a discharge treatment such as corona treatment or RIE (reactive ion etching) treatment. Due to radicals and ions generated in plasma, functional groups can be imparted onto the surface of the substrate film, providing a chemical effect to improve adhesiveness.

Here, the corona treatment is not applied to the surface of the barrier laminate film layer (barrier laminate film) 3 on which the first adhesive resin layer 4 is laminated (vapor deposition surface).

The barrier laminate film layer 3 is preferably configured of, for example, PET as a substrate film and a gas barrier cover layer deposited on the vapor deposition thin film layer as a coat layer.

The gas barrier cover layer is provided to prevent occurrence of a variety of secondary damage to the vapor deposition thin film layer and impart high barrier properties. The gas barrier cover layer preferably contains a component which includes at least one selected from the group consisting of hydroxyl group-containing polymer compound, metal alkoxide, metal alkoxide hydrolysate and metal alkoxide polymer in view of obtaining good barrier properties.

The hydroxyl group-containing polymer compound specifically include, for example, a water-soluble polymer such as polyvinyl alcohol, polyvinylpyrrolidone or starch. In particular, high barrier properties can be obtained by using polyvinyl alcohol.

The metal alkoxide is a compound represented by a general formula: M(OR)n (where M represents a metal atom such as Si, Ti, Al or Zr, R represents an alkyl group such as —CH₃ or —C₂H₅, and n represents an integer corresponding to a valence of M). Specifically, tetraethoxysilane [Si(OC₂H₅)₄], triisopropoxy aluminum [Al(O-iso-C₃H₇)₃] or the like may be used. Tetraethoxysilane and triisopropoxy aluminum are preferred since they are relatively stable in an aqueous solvent after hydrolysis. Further, examples of the metal alkoxide hydrolysate and metal alkoxide polymer include silicic acid (Si(OH)₄) as a tetraethoxysilane hydrolysate or a tetraethoxysilane polymer, and aluminum hydroxide (Al(OH)₃) as a tripropoxy aluminum hydrolysate or a tripropoxy aluminum polymer.

<Sealant Layer>

The sealant layer 5 is provided as a resin film formed by extrusion lamination by which a molten resin is extruded from a T-die and laminated on the barrier laminate film layer 3 via the second adhesive resin layer 6, or as a cast film formed of a molten resin extruded from a T-die.

Alternatively, a resin film formed by blown film extrusion, which allows for film formation at an extrusion temperature of 200° C. or lower, may be laminated on the barrier laminate film layer 3 via the second adhesive resin layer 6, or a resin film may be provided by the Neelam method by which a film is formed at an extrusion temperature of lower than 300° C. by using a T-die and bonded in-line to the barrier laminate film layer 3 via the second adhesive resin layer 6.

Examples of the resin film provided by blown film extrusion or the thermal melting resin used for the resin film provided by the Neelam method in the sealant layer 5 include acid-modified polyolefin resins, which are polyolefin resins such as low density polyethylene (LDPE), medium density polyethylene (MDPE), high density polyethylene (HDPE), linear low density polyethylene (LLDPE), polypropylene (PP), ethylene-vinyl acetate copolymer (EVA), ionomer resin, ethylene-methyl acrylate copolymer (EMA), ethylene-acrylate acid copolymer (EAA), ethylene-methacrylate acid copolymer (EMAA), ethylene-propylene copolymer (EPM), methylpentene polymer, polyethylene and polypropylene, modified by unsaturated carboxylic acid such as acrylic acid, methacrylic acid, maleic acid, maleic anhydride, fumaric acid, and itaconic acid. Preferably, the thickness is approximately in the range of 20 to 70 μm.

Specifically, the sealant layer 5 is preferably a low density polyethylene (LDPE), and more preferably an additive-free low density polyethylene. The additive-free low density polyethylene is a resin to which an additive such as slipping agent, anti-blocking agent, or anti-oxidation agent is not added.

Further, when the sealant layer 5 is a resin film formed by blown film extrusion, the film can be bonded by extrusion lamination. In this case, a thermal melting resin is used as the second adhesive resin layer 6. Examples of the thermal melting resin used include acid-modified polyolefin resins, which are polyolefin resins such as low density polyethylene (LDPE), medium density polyethylene (MDPE), high density polyethylene (HDPE), linear low density polyethylene (LLDPE), polypropylene (PP), ethylene-vinyl acetate copolymer (EVA), ionomer resin, ethylene-methyl acrylate copolymer (EMA), ethylene-acrylate acid copolymer (EAA), ethylene-methacrylate copolymer (EMAA), ethylene-propylene copolymer (EPM), methylpentene polymer, polyethylene and polypropylene, which are modified by unsaturated carboxylic acid such as acrylic acid, methacrylic acid, maleic acid, maleic anhydride, fumaric acid, and itaconic acid.

The thickness of the sealant layer 5 appropriately depends on the application, and is preferably approximately in the range of 3 to 70 μm.

Further, the sealant layer 5 may be bonded by dry lamination by using a resin film formed by blown film extrusion. In the case of dry lamination bonding, a dry lamination adhesive is used as the second adhesive resin layer 6. The dry lamination adhesive may be appropriately selected, and is preferably, for example, a urethane-based adhesive composed of polyester polyol or polyester polyurethane polyol as a base resin and an isocyanate-based hardener as a hardener. The amount of dry lamination adhesive to be applied is preferably in the range of 1 to 6 g/m² in dry-cured weight.

When the sealant layer 5 is formed by extrusion from a T-die at an extrusion temperature of lower than 300° C. and bonded in-line to the barrier laminate film layer 3, a dry lamination adhesive is used as the second adhesive resin layer 6 interposed therebetween. The dry lamination adhesive may be appropriately selected, and is preferably, for example, a urethane-based adhesive composed of polyester polyol or polyester polyurethane polyol as a base resin and an isocyanate-based hardener as a hardener. The amount of dry lamination adhesive to be applied is preferably in the range of 1 to 6 g/m² in dry-cured weight.

The “sealant layer” may be made of any polyolefin having sealing properties, and is preferably LLDPE. The “sealant layer” preferably has a thickness approximately in the range of 8 to 300 μm, and more preferably of 20 to 60 μm. An additive may be added as necessary.

Further, the second adhesive resin layer is preferably made of “NUCREL AN4228C” (manufactured by Dupont-Mitsui Polychemicals Co. Ltd) or “ADMER SE810” (manufactured by Mitsui Chemicals, Inc.).

The laminate 10 thus formed is formed into a box shape to provide a paper container for liquid.

The shape of the paper container for liquid may be, for example, a prismatic body with a flat bottom and a gable top (gable top shape), or a flat top (brick shape) (see FIG. 3B), or a top having an inclined front surface and a flat rear surface.

### EXAMPLES

With reference to FIGS. 1, 2A, 2B, 2C, 2D, 3A, 3B, 4, 5A, 5B, 5C, 5D, 6, 7A, 7B, 7C, 7D, 8, 9A, 9B, 9C, 9D, and 9E, examples of the paper container for liquid and the method for producing the same will be described.

(Sample 1)

First, in the “first extrusion lamination step,” the substrate 1 made of a paper sheet (350 g/m², density of 0.78 g/cm³) was provided (FIG. 2A). Then, low density polyethylene was provided on the first surface of the substrate 1 by extrusion lamination to form the thermoplastic resin layer 2. Thus, the laminate shown in FIG. 2B was provided. “Novatec LC600A” (manufactured by Japan Polyethylene Corporation) was used as a material for the thermoplastic resin layer 2. The thickness of the thermoplastic resin layer 2 was 30 μm.

Specifically, the laminate shown in FIG. 2B was formed by using an extruder lamination machine under the following conditions.

Extrusion temperature: 320° C. or higher

Surface treatment: Corona treatment (50 Wh/m²) applied to the first surface of the substrate 1

Subsequently, in the “second extrusion lamination step,” the second surface of the substrate 1 and the vapor deposition surface (coat surface) 3a of the barrier laminate film layer 3 were bonded to each other via a low density polyethylene of the first adhesive resin layer 4 by an extrusion lamination technique. A film used for the barrier laminate film layer 3 was formed by processing one surface of a 12 μm-thick polyethylene terephthalate film with a reactive ion etching treatment, and laminating thereon in sequence an aluminum oxide vapor deposition layer and a gas barrier cover layer formed by applying and drying a coating liquid containing hydrolysate of polyvinyl alcohol and tetraethoxysilane. The thickness of the barrier laminate film layer 3 was 12 μm. Further, “ADMER SE810” (manufactured by Mitsui Chemicals, Inc.) was used as a material for the first adhesive resin layer 4. The thickness of the first adhesive resin layer 4 was 20 Surface treatment was not applied to the second surface of the substrate 1 nor to either surface of the barrier laminate film layer 3.

Specifically, the laminate shown in FIG. 2C was formed under the following conditions.

Extrusion temperature: 300° C.

Surface treatment: Not applied

Subsequently, in the “third extrusion lamination step,” the sealant layer 5 was laminated on a surface of the barrier laminate film layer 3 on a side opposite to the vapor deposition surface 3a by co-extrusion lamination technique by using the second adhesive resin layer 6 to thereby form the laminate 10 shown in FIG. 2D. “NUCREL AN4228C” (manufactured by Dupont-Mitsui Polychemicals Co. Ltd) was used for the second adhesive resin layer 6. The thickness of the second adhesive resin layer 6 was 20 μm. Further, “EVOLUE SP1071C” (manufactured by Prime Polymer Co., Ltd.) was used as a material for the sealant layer 5. The thickness of the sealant layer 5 was 30 μm.

Specifically, the laminate 10 shown in FIG. 2D was formed under the following conditions.

Extrusion temperature: 310 to 320° C.

Surface treatment: Corona treatment (50 Wh/m²) applied to the surface of the barrier laminate film layer which faces the sealant layer

The sheet-shaped laminate 10 thus formed was processed into a tape-shape and cut at a predetermined length in the “slitting step,” and the laminate 10 cut at the predetermined length in the slitting step was formed into a box shape in the “forming step.” That is, the laminate 10 was folded with both ends overlapped with each other to form a rectangular shape. Then, the bottom was formed, and a spout was attached to the top. Thus, the paper container for liquid for Sample 1 was provided.

(Sample 2)

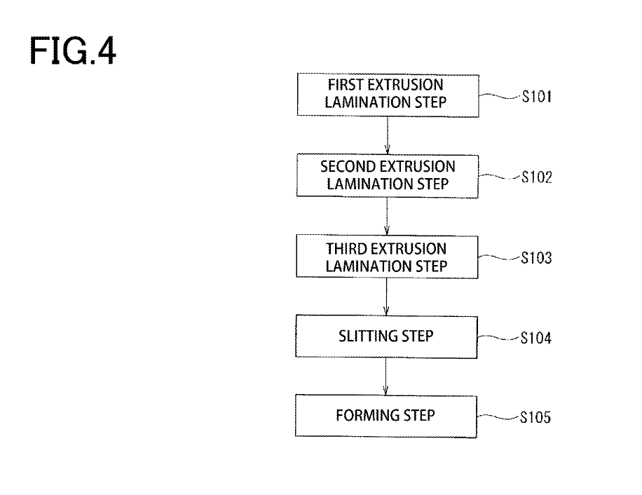

The paper container for liquid of Sample 2 was formed in the same manner as Sample 1 except that the corona treatment was applied to the second surface of the substrate 1 and the vapor deposition surface of the barrier laminate film layer 3 of the above Sample 1. The second surface of the substrate 1 refers to a surface of the substrate 1 on which the barrier laminate film layer 3 is provided via the first adhesive resin layer 4. That is, in Sample 2, corona treatment (50 Wh/m²) was applied on both surfaces of the substrate 1, and both surfaces of the barrier laminate film layer 3. As shown in FIG. 4, a method for producing Sample 2 includes a first extrusion lamination step S101, a second extrusion lamination step S102, a third extrusion lamination step S103, a slitting step S104, and a forming step S105.

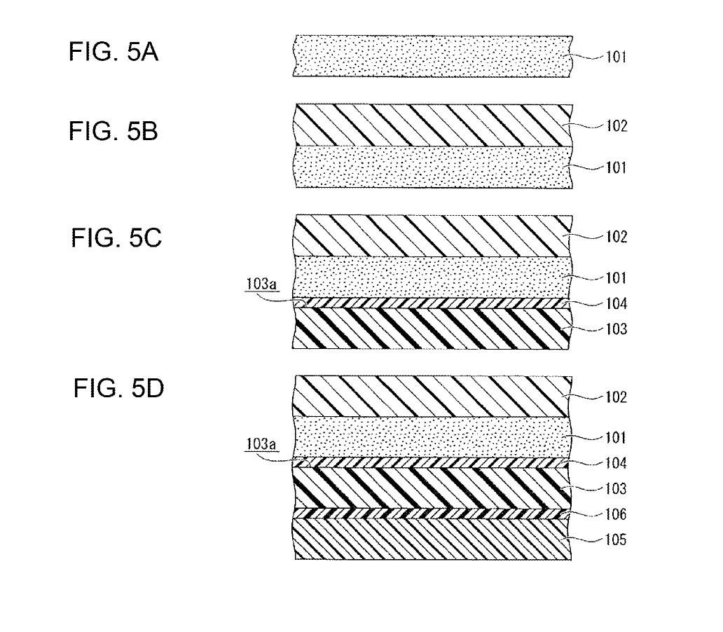

First, in the “first extrusion lamination step,” a substrate 101 made of a paper sheet (350 g/m², density of 0.78 g/cm³) was provided (FIG. 5A). Then, low density polyethylene was provided on the first surface of the substrate 101 by extrusion lamination to form a thermoplastic resin layer 102. Thus, a laminate shown in FIG. 5B was provided. “Novatec LC600A” (manufactured by Japan Polyethylene Corporation) was used as a material for the thermoplastic resin layer 102. The thickness of the thermoplastic resin layer 102 was 30

Specifically, the laminate shown in FIG. 5B was formed by using an extruder lamination machine under the following conditions.

Extrusion temperature: 320° C. or higher

Surface treatment: Corona treatment (50 Wh/m²) applied to the first surface of the substrate 101

Subsequently, in the “second extrusion lamination step,” the second surface of the substrate 101 and a vapor deposition surface (coat surface) 103a of a barrier laminate film layer 103 were bonded to each other via a low density polyethylene of a first adhesive resin layer 104 by extrusion lamination technique. A film used for the barrier laminate film layer 103 was formed by processing one surface of a 12 μm-thick polyethylene terephthalate film with a reactive ion etching treatment, and laminating thereon in sequence an aluminum oxide vapor deposition layer and a gas barrier cover layer formed by applying and drying a coating liquid containing hydrolysate of polyvinyl alcohol and tetraethoxysilane. The thickness of the barrier laminate film layer 103 was 12 μm. Further, “ADMER SE810” (manufactured by Mitsui Chemicals, Inc.) was used as a material for the first adhesive resin layer 104. The thickness of the first adhesive resin layer 104 was 20 μm.

Specifically, the laminate shown in FIG. 5C was formed under the following conditions.

Extrusion temperature: 300° C.

Surface treatment: Corona treatment (50 Wh/m²) applied to the second surface of the substrate 1

Corona treatment (50 Wh/m²) applied to the vapor deposition surface 103a of the barrier laminate film layer 103

Subsequently, in the “third extrusion lamination step,” a sealant layer 105 was laminated on a surface of the barrier laminate film layer 103 on a side opposite to the vapor deposition surface 103a by co-extrusion lamination technique by using the second adhesive resin layer 106 to thereby form a laminate 110 shown in FIG. 5D. “NUCREL AN4228C” (manufactured by Dupont-Mitsui Polychemicals Co. Ltd) was used for the second adhesive resin layer 106. The thickness of the second adhesive resin layer 106 was 20 Further, “EVOLUE SP1071C” (manufactured by Prime Polymer Co., Ltd.) was used as a material for the sealant layer 105. The thickness of the sealant layer 105 was 30

Specifically, the laminate 110 shown in FIG. 5D was formed under the following conditions.

Extrusion temperature: 310 to 320° C.

Surface treatment: Corona treatment (50 Wh/m²) applied to the surface of the barrier laminate film layer 103 which faces the sealant layer 105

The sheet-shaped laminate 110 thus formed was processed into a tape-shape and cut at a predetermined length in the “slitting step,” and the laminate 110 cut at the predetermined length in the slitting step was formed into a box shape in the “forming step.” That is, the laminate 110 was folded with both ends overlapped with each other to form a rectangular shape. Then, the bottom was formed, and a spout was attached to the top. Thus, the paper container for liquid for Sample 2 was provided.

(Sample 3)

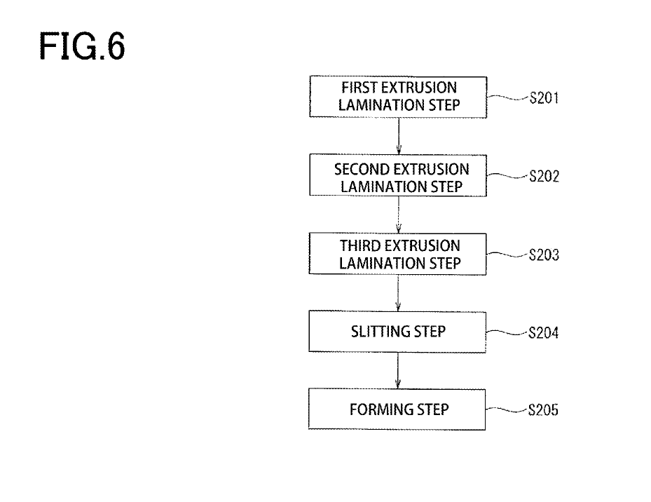

The paper container for liquid of Sample 3 was formed in the same manner as Sample 1 except that the second surface of the substrate and a surface of the barrier laminate film layer on a side opposite to the vapor deposition surface were bonded to each other via a low density polyethylene of the first adhesive resin layer by extrusion lamination technique in the “second extrusion lamination step,” and the vapor deposition surface of the barrier laminate film layer was laminated on the sealant layer by a co-extrusion lamination technique by using the second adhesive resin layer in the “third extrusion lamination step” in the above Sample 1. As shown in FIG. 6, a method for producing Sample 3 includes a first extrusion lamination step S201, a second extrusion lamination step S202, a third extrusion lamination step S203, a slitting step S204, and a forming step S205.

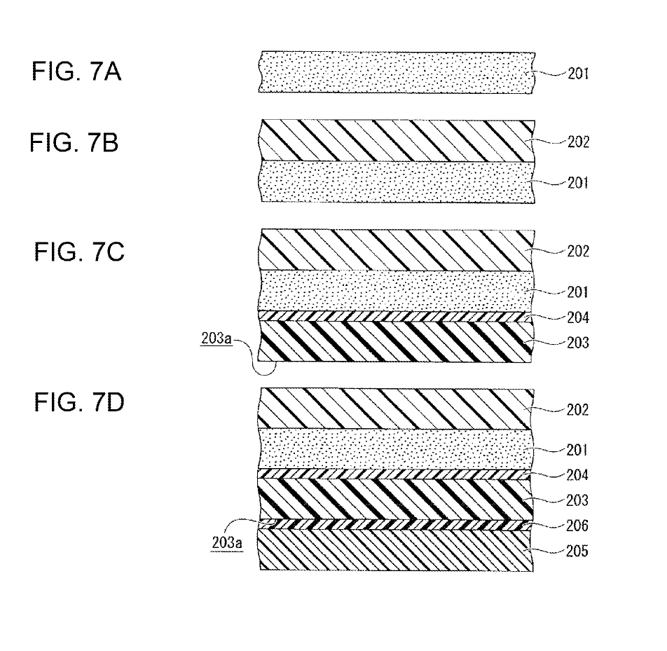

First, in the “first extrusion lamination step,” a substrate 201 made of a paper sheet (350 g/m², density of 0.78 g/cm³) was provided (FIG. 7A). Then, low density polyethylene was provided on the first surface of the substrate 201 by extrusion lamination to form a thermoplastic resin layer 202. Thus, the laminate shown in FIG. 7B was provided. “Novatec LC600A” (manufactured by Japan Polyethylene Corporation) was used as a material for the thermoplastic resin layer 202. The thickness of the thermoplastic resin layer 202 was 30 μm.

Specifically, the laminate shown in FIG. 7B was formed by using an extruder lamination machine under the following conditions.

Extrusion temperature: 320° C. or higher

Surface treatment: Corona treatment (50 Wh/m²) applied to the first surface of the substrate 201

Subsequently, in the “second extrusion lamination step,” the second surface of the substrate 201 and a surface of a barrier laminate film layer 203 on a side opposite to a vapor deposition surface (coat surface) 203a were bonded to each other via a low density polyethylene of a first adhesive resin layer 204 by an extrusion lamination technique. A film used for the barrier laminate film layer 203 was formed by processing one surface of a 12 μm-thick polyethylene terephthalate film with a reactive ion etching treatment, and laminating thereon in sequence an aluminum oxide vapor deposition layer and a gas barrier cover layer formed by applying and drying a coating liquid containing hydrolysate of polyvinyl alcohol and tetraethoxysilane. The thickness of the barrier laminate film layer 203 was 12 μm. Further, “ADMER SE810” (manufactured by Mitsui Chemicals, Inc.) was used as a material for the first adhesive resin layer 204. The thickness of the first adhesive resin layer 204 was 20 μm.

Specifically, the laminate shown in FIG. 7C was formed under the following conditions.

Extrusion temperature: 300° C.

Surface treatment: Not applied to the second surface of the substrate 201

Corona treatment (50 Wh/m²) applied to a surface of the barrier laminate film layer 203 on a side opposite to the vapor deposition surface (coat surface) 203a

Subsequently, in the “third extrusion lamination step,” a sealant layer 205 was laminated on the vapor deposition surface 203a of the barrier laminate film layer 203 by co-extrusion lamination technique by using the second adhesive resin layer 206 to thereby form a laminate 210 shown in FIG. 7D. “NUCREL AN4228C” (manufactured by Dupont-Mitsui Polychemicals Co. Ltd) was used for the second adhesive resin layer 206. The thickness of the second adhesive resin layer 206 was 20 μm. Further, “EVOLUE SP1071C” (manufactured by Prime Polymer Co., Ltd.) was used as a material for the sealant layer 205. The thickness of the sealant layer 205 was 30 μm.

Specifically, the laminate 210 shown in FIG. 7D was formed under the following conditions.

Extrusion temperature: 310 to 320° C.

Surface treatment: Not applied

The sheet-shaped laminate 210 thus formed was processed into a tape-shape and cut at a predetermined length in the “slitting step,” and the laminate 210 cut at the predetermined length in the slitting step was formed into a box shape in the “forming step.” That is, the laminate 210 was folded with both ends overlapped with each other to form a rectangular shape. Then, the bottom was formed, and a spout was attached to the top. Thus, the paper container for liquid for Sample 3 was provided.

(Sample 4)

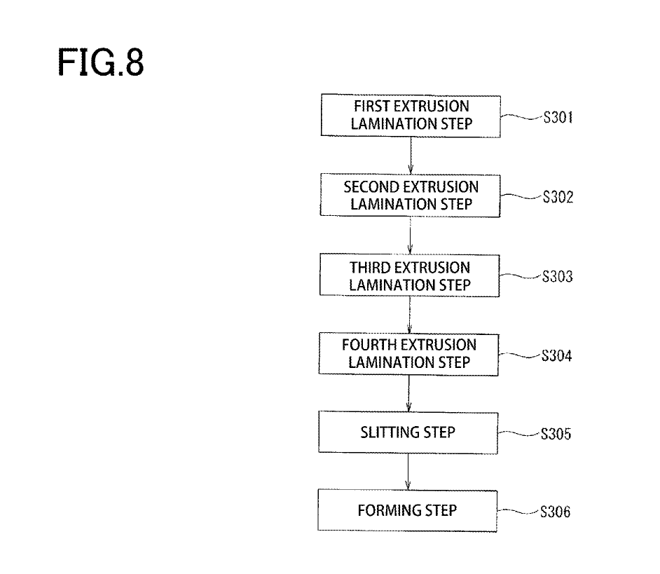

The paper container for liquid of Sample 4 was formed in the same manner as Sample 1 except that an anchor coat layer was disposed on the vapor deposition surface formed on an inner surface of the barrier laminate film layer (surface of the barrier laminate film layer 3 on a side opposite to that facing the substrate), and corona treatment was applied to an outer surface of the barrier laminate film layer (surface on a side opposite to the vapor deposition surface of the barrier laminate film layer) in the above Sample 1. As shown in FIG. 8, a method for producing Sample 4 includes a first extrusion lamination step S301, a second extrusion lamination step S302, a third extrusion lamination step S303, a fourth extrusion lamination step S304, a slitting step S305, and a forming step S306.

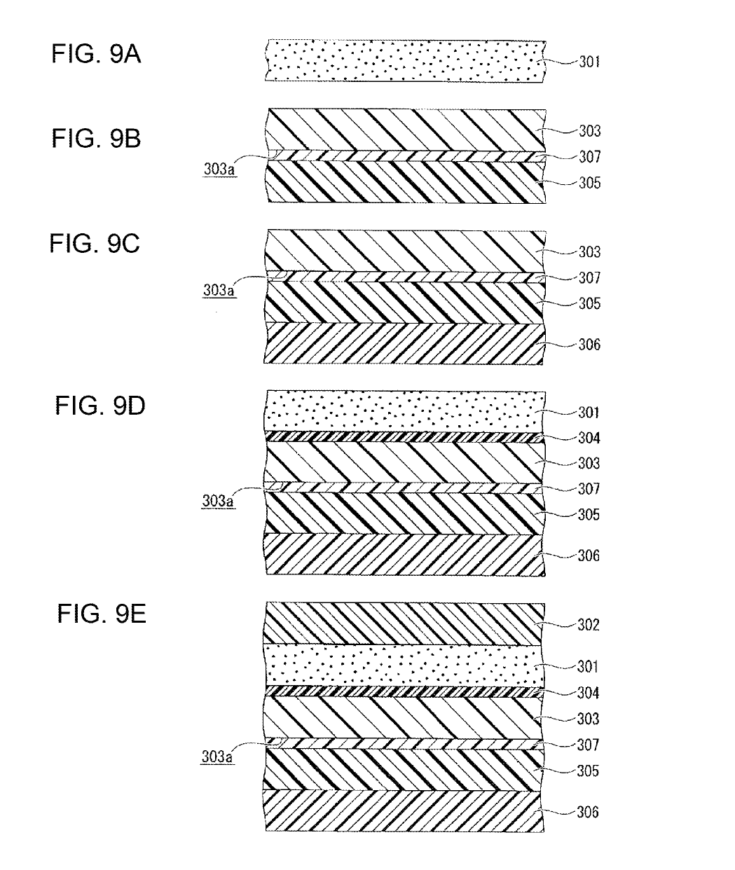

In the “first extrusion lamination step,” the substrate 301 made of a paper sheet (350 g/m², density of 0.78 g/cm³) was provided (FIG. 9A). Further, an anchor coat layer 307 was formed on a vapor deposition surface 303a of a barrier laminate film layer 303, and a thermoplastic resin layer 305 was laminated on the anchor coat layer 307 by extrusion lamination technique to thereby form a laminate shown in FIG. 9B. A material which is the same as the material for the barrier laminate film layer 3 in Sample 1 was used for the barrier laminate film layer 303. The thickness of the barrier laminate film layer 303 was 12 “Novatec LC600A” (manufactured by Japan Polyethylene Corporation) was used as a material for the thermoplastic resin layer 305. The thickness of the thermoplastic resin layer 305 was 20

Specifically, the laminate shown in FIG. 9B was formed by using an extruder lamination machine under the following conditions.

Extrusion temperature: 290° C. or lower

Surface treatment: Not applied

Two-part curing type aliphatic ester-based urethane resin was used as an anchor coat agent.

Subsequently, in the “second extrusion lamination step,” a sealant layer 306 was laminated on the thermoplastic resin layer 305 by extrusion lamination technique to thereby form a laminate shown in FIG. 9C. “EVOLUE SP1071C” (manufactured by Prime Polymer Co., Ltd.) was used as a material for the sealant layer 306. The thickness of the sealant layer 306 was 30

Specifically, the laminate shown in FIG. 9C was formed under the following conditions.

Extrusion temperature: 290° C. or lower

Surface treatment: Not applied

Subsequently, in the “third extrusion lamination step,” the first surface of the substrate 301 and a surface of the barrier laminate film layer 303 on a side opposite to the vapor deposition surface 303a were bonded to each other via a low density polyethylene of a first adhesive resin layer 304 by an extrusion lamination technique to thereby form a laminate shown in FIG. 9D. “NUCREL AN4228C” (manufactured by Dupont-Mitsui Polychemicals Co. Ltd) was used as a material for the first adhesive resin layer 304. The thickness of the first adhesive resin layer 304 was 20

Specifically, the laminate shown in FIG. 9D was formed under the following conditions.

Extrusion temperature: 310 to 320° C.

Surface treatment: Corona treatment (50 Wh/m²) applied to the first surface of the substrate 301

Subsequently, in the “fourth extrusion lamination step,” a low density polyethylene was provided on the second surface of the substrate 301 by extrusion lamination to form a thermoplastic resin layer 302. Thus, the laminate shown in FIG. 9E was provided. “Novatec LC600A” (manufactured by Japan Polyethylene Corporation) was used as a material for the thermoplastic resin layer 302. The thickness of the thermoplastic resin layer 302 was 30 Specifically, the laminate 310 shown in FIG. 9E was formed under the following conditions.

Extrusion temperature: 320° C. or higher

Surface treatment: Corona treatment (50 Wh/m²) applied to the second surface of the substrate 301

The sheet-shaped laminate 310 thus formed was processed into a tape-shape and cut at a predetermined length in the “slitting step,” and the laminate 310 cut at the predetermined length in the slitting step was formed into a box shape in the “forming step.” That is, the laminate 310 was folded with both ends overlapped with each other to form a rectangular shape. Then, the bottom was formed, and a spout was attached to the top. Thus, the paper container for liquid for Sample 4 was provided.

<Evaluation>

The paper containers for liquid of Samples 1, 2, 3, and 4 thus formed were evaluated by a water resistance test conducted under the following conditions.

[Outline of Water Resistance Test]

Evaluation of lamination strength after storage under high humidity environments

Tester (manufactured by Shimadzu Corporation: compact table-top tester EZ-TESTL)

Sample width 15 mm

Tensile rate: 300 mm/min

<Lamination Strength Depending on Application of Corona Treatment>

As shown in Table 1, a sheet-shaped laminate of Sample 1 without a corona treatment applied on the vapor deposition surface of the barrier laminate film layer, and a sheet-shaped laminate of Sample 2 with a corona treatment applied on the vapor deposition surface were used as test samples. Each sample was immersed in water and stored at 40° C. and 90% RH for one week. The sample after storage was prepared into a 15 mm width, and the lamination strength was measured by a tester (manufactured by Shimadzu Corporation: compact table-top tester EZ-TESTL). The measurements are mean values. Table 1 shows the measurement results. In Table 1, the unit of the lamination strength is [N/15 mm].

TABLE 1

| | | | Lamination |
|---|---|---|---|
| | | | strength |
| | Corona | | mean value |
| | treatment | Measured location | [N/15 mm] |
| Sample 2 | Applied | Vapor deposition | 0.2 or less |
| | | surface (103a) | |
| Sample 1 | Not applied | Vapor deposition | 2.5 or more |
| | | surface (3a) | |

[Evaluation of Water Resistance Test]

In the water resistance test, the lamination strength of 2.0 [N/15 mm] or more was evaluated as “paper container for liquid with high water resistance.” In Table 1, “0.2 or less” in the lamination strength of Sample 2 indicates that the value was equal to or lower than the detection limit of the tensile tester.

As shown in Table 1, it was found that the paper container for liquid of Sample 1 was superior to the paper container for liquid of Sample 2 in the evaluation of lamination strength after storage under high humidity environments.

Further, it was also found that the paper container for liquid of Sample 1 had sufficient strength as a container after storage at 40° C. and 90% RH for one month when it was formed to maintain adhesion strength under high humidity environments, have an adhesive resin ADMER SE810 adhered without surface treatment to the barrier laminate film layer, which protects the quality of contents and maintains the outer appearance of the container, and have a vapor deposition thin film layer of the barrier laminate film layer formed to be oriented outside the container.

<Lamination Strength Depending on Orientation of Vapor Deposition Surface of Barrier Laminate Film Layer>

Further, the relationship between the orientation of the vapor deposition surface of the barrier laminate film layer and the lamination strength was measured.

The orientation of the vapor deposition surface of the barrier laminate film layer and the lamination side of the laminates of Sample 1 and Sample 3 were specified as shown in Table 2. The laminates were formed into a box shape to form a test sample, which were stored at 40° C. and 90% RH (manufactured by Okuno Technical Research Institute Co., Ltd.: high temperature and high humidity bath) for one month. The sample after storage was prepared into a 15 mm width, and the lamination strength was measured by a tester (manufactured by Shimadzu Corporation: compact table-top tester EZ-TESTL). Table 2 shows the measurement results. In Table 2, the unit of the lamination strength is [N/15 mm].

TABLE 2

| | Orientation of vapor | | |
|---|---|---|---|
| | deposition surface of | | Lamination |
| | barrier laminate film | | strength |
| | layer in packaging | | mean value |
| | material | Measured location | [N/15 mm] |
| Sample 3 | Inside | Surface on a side | 2.5 or more |
| | | opposite to the vapor | |
| | | deposition surface | |
| | | (203a) | |
| | | Vapor deposition | 2.0 |
| | | surface (203a) | |
| Sample 1 | Outside | Vapor deposition | 2.5 or more |
| | | surface (3a) | |
| | | Surface on a side | 2.5 or more |
| | | opposite to the vapor | |
| | | deposition surface | |
| | | (3a) | |

For the relationship between the orientation of the vapor deposition surface and the lamination strength, the lamination strength of 2.0 [N/15 mm] or more was evaluated as “paper container for liquid with high water resistance.”

As shown in Table 2, it was found that, when the laminate was formed into a box-shaped paper container for liquid, the paper container for liquid of Sample 1 having the vapor deposition surface of the barrier laminate film layer oriented outside the container and the paper container for liquid of Sample 3 having the vapor deposition surface of the barrier laminate film layer oriented inside the container both had high water resistance.

<Lamination Strength Depending on Presence or Absence of Anchor Coat Layer>

Further, the relationship between the presence or absence of the anchor coat layer and lamination strength was measured.

As shown in Table 3, the laminate of Sample 1 without having an anchor coat layer and the laminate of Sample 4 having an anchor coat layer were each formed into a box shape as test samples. Each sample was immersed in water and stored at 40° C. and 90% RH for one week. The sample after storage was prepared into a 15 mm width, and the lamination strength was measured by a tester (manufactured by Shimadzu Corporation: compact table-top tester EZ-TESTL). The measurements are mean values. Table 3 shows the measurement results. In Table 3, the unit of the lamination strength is [N/15 mm].

TABLE 3

| | Presence or | | Lamination |
|---|---|---|---|
| | absence of | | strength |
| | anchor | | mean value |
| | coat layer | Measured location | [N/15 mm] |
| Sample 4 | Provided | Vapor deposition | 2.5 or more |
| | | surface (303a) | |
| Sample 1 | Not provided | Vapor deposition | 2.5 or more |
| | | surface (3a) | |

As shown in Table 3, the paper container for liquid of Sample 1 and the paper container for liquid of Sample 4 both had high water resistance. However, since the method for producing the paper container for liquid of Sample 1 does not include forming of an anchor coat layer, which may limit the production rate, it is possible to reduce the number of processes and the production loss, and thus improve the yield compared with the method for producing the paper container for liquid of Sample 4.

[Evaluation of Formability of Paper Container for Liquid]

In evaluation of the formability of paper container for liquid, for each of the sheet-shaped laminate 10 of Sample 1 and the sheet-shaped laminate 310 of Sample 4, a yield angle at a score line folding section and a yield value depending on the presence and absence of the anchor coat layer were measured. The results are shown in Table 4.

The yield angle (°) and the corresponding yield value (N) were measured by using a bending strength tester (manufactured by Katayama Steel Rule Die Inc., BST-150). Specifically, a 90-degree bending test was performed to each of the score line in the vertical direction (MD) and the score line in the horizontal direction (TD), and a fold angle when the behavior of the packaging material against the bending stress changes from elastic deformation to plastic deformation and a maximum stress were measured as the yield angle and the yield value, respectively. The values are mean values.

In the evaluation of formability, the paper container for liquid in the aspect as shown in FIG. 3B was regarded as having good formability when the yield angle (°) at the vertical score line was 45 (°) or less and the yield value (N) was 1.50 (N) or less, and the yield angle (°) at the horizontal score line was 30 (°) or less and the yield value (N) was 2.00 (N) or less.

TABLE 4

| | Presence or | | | |
|---|---|---|---|---|
| | absence of | | Yield angle | Yield value |
| | anchor | | mean value | mean value |
| | coat layer | Score line | [°] | [N] |
| Sample 4 | Provided | Vertical | 88.4 | 1.83 |
| | | score line | | |
| | | Horizontal | 36.3 | 2.19 |
| | | score line | | |
| Sample 1 | Not provided | Vertical | 37.9 | 1.04 |
| | | score line | | |
| | | Horizontal | 21.5 | 1.44 |
| | | score line | | |

As shown in Table 4, it was found that the paper container for liquid of Sample 1 had high formability of the paper container for liquid in the aspect shown in FIG. 3B due to not having an anchor coat layer compared with the paper container for liquid of Sample 4.

Further, the paper container for liquid of Sample 1 had good dead-fold characteristics for the container (characteristics of holding the folded shape), and thus improved formability, due to not having an anchor coat layer compared with the paper container for liquid of Sample 4.

### INDUSTRIAL APPLICABILITY

The method for producing a paper container for liquid and the paper container for liquid produced by the same according to the present invention use a laminate having high water resistance and formability, and characteristics required for a packaging film such as dead-fold characteristics, transparency, dimensional stability, rigidity, and printability in good balance. Accordingly, application to paper containers for liquid used for liquid beverages and food products, especially for boiling and retort sterilization, are advantageously expected. The method for producing a paper container for liquid and the paper container for liquid produced by the same according to the present invention are not limited to those described above.

### REFERENCE SIGNS LIST

10: Laminate; 1: Substrate; 2: Thermoplastic resin layer; 3: Barrier laminate film layer; 3a: Vapor deposition surface (a surface of the barrier laminate film layer having a vapor deposition layer); 4: First adhesive resin layer; 5: Sealant layer; 6: Second adhesive resin layer.

What is claimed is:

1. A method for producing a paper container for liquid, comprising the steps of:
a bonding step of bonding a first surface of a substrate and a vapor deposition surface of a barrier laminate film layer via a first adhesive resin layer without applying a corona treatment to the vapor deposition surface of the barrier laminate film layer;
a lamination step of laminating at least a second adhesive resin layer on a surface of the barrier laminate film layer on a side opposite to the vapor deposition surface; and
a forming step of forming a laminate into a box shape after the bonding step and the lamination step, the laminate including at least the substrate, the first adhesive resin layer, the barrier laminate film layer, and the second adhesive resin layer.

2. A method for producing a paper container for liquid, comprising the steps of:
a lamination step of laminating a first adhesive resin layer without applying a corona treatment to a vapor deposition surface of a barrier laminate film layer;
a bonding step of bonding a surface of the barrier laminate film layer on a side opposite to the vapor deposition surface to a first surface of a substrate via a second adhesive resin layer; and
a forming step of forming a laminate into a box shape after the lamination step and the bonding step, the laminate including at least the substrate, the second adhesive resin layer, the barrier laminate film layer, and the first adhesive resin layer.

3. The method for producing a paper container for liquid of claim 1, further comprising a step of providing a thermoplastic resin layer on a second surface of the substrate before the forming step, and,
wherein the lamination step includes laminating a sealant layer on a surface of the barrier laminate film layer on a side opposite to the vapor deposition surface via the second adhesive resin layer.

4. The method for producing a paper container for liquid of claim 2, further comprising a step of providing a thermoplastic resin layer on a second surface of the substrate before the forming step, wherein
the lamination step includes laminating a sealant layer on the vapor deposition surface of the barrier laminate film layer via the first adhesive resin layer.

5. A paper container for liquid produced by forming a laminate into a shape, the laminate comprising:
a barrier laminate film layer;
a first adhesive resin layer laminated on a first surface of the barrier laminate film layer;
a second adhesive resin layer laminated on a second surface of the barrier laminate film layer; and
a substrate laminated on one of a surface of the first adhesive resin layer on a side opposite to that facing the barrier laminate film layer and a surface of the second adhesive resin layer on a side opposite to that facing the barrier laminate film layer, wherein
the first adhesive resin layer is laminated with a vapor deposition surface formed on the first surface of the barrier laminate film layer being a non-corona treated surface.

6. The paper container for liquid of claim 5, wherein the laminate further includes:
a thermoplastic resin layer laminated on a surface of the substrate on a side opposite to that facing the barrier laminate film layer; and
a sealant layer laminated on the other of the surface of the first adhesive resin layer on a side opposite to that facing the barrier laminate film layer and the surface of the second adhesive resin layer on a side opposite to that facing the barrier laminate film layer.
